(19) United States
(12) Patent Application Publication
(10) Pub. No.: US 2026/0261088 A1
(43) Pub. Date: Sep. 3, 2026

(54) INSULATING BEAD FOR RF CONNECTOR

(71) Applicant: Samtec, Inc., New Albany, IN (US)

(72) Inventors: Joseph B. SEGER, JR., New Albany, IN (US); Daniel R. BIRCH, New Albany, IN (US); David S. BERAUN, New Albany, IN (US); Troy B. HOLLAND, New Albany, IN (US)

(21) Appl. No.: 18/881,948

(22) PCT Filed: Jul. 7, 2023
(86) PCT No.: PCT/US2023/027082

§ 371 Date: Jan. 7, 2025

Related U.S. Application Data
(60) Provisional application No. 63/359,496, filed on Jul. 8, 2022.

(51) Int. Cl. H01R 43/18; H01R 24/44; H01R 24/50

(52) U.S. Cl. CPC H01R 43/18; H01R 24/44; H01R 24/50

(57) ABSTRACT

An RF connector is tuned by a process of determining an impedance profile for the RF connector, determining a structure of the insulating bead that provides the impedance profile, and forming the insulating bead by an additive manufacturing process. The additive manufacturing process can be a three-dimensional (3D) printing process.

### CROSS REFERENCE TO RELATED APPLICATIONS

This application claims the benefit of U.S. Patent Application No. 63/359,496 filed on Jul. 8, 2022. The entire contents of this application are hereby incorporated by reference.

### BACKGROUND OF THE INVENTION

### 1. Field of the Invention

The present invention generally relates to radio-frequency (RF) or coaxial-board connectors.

### 2. Description of the Related Art

In general, known RF connectors include an electrically non-conductive bead (insulating bead) that electrically isolates a coaxial signal conductor from a metal housing of the RF connector. The insulating beads of known RF connectors are typically manufactured by an insert molding process or an extrusion process. However, insert molding and extrusion processes can only provide insulating beads with relatively simple physical structures. Known insulating beads also often include a slit or cutout to enable the insulating bead to be snapped onto a conductor of an RF connector, which can lower the structural strength and reduce the electrical characteristics of the insulting bead.

In addition, impedance tuning of known insulating beads may be difficult due to manufacturing tolerances in insert molding and extrusion processes. Impedance tuning of known insulating beads may also be difficult due to commonly-used materials, such a fluoropolymers, having limited dielectric characteristics. Known insulating beads are also generally unable to be structured to filter out specific frequencies, for example, unwanted resonant frequencies.

Although known RF connectors have been provided with holes or voids, such holes or voids have typically been provided by machining the known RF connectors with a screw machine or the like. However, such process can leave burrs, significantly reduce structural integrity, and are only able to provide a limited amount of void space. Accordingly, known RF connectors have not been able to provide both structural strength and a low effective dielectric constant.

A portion of a coaxial signal conductor of known RF connectors that is surrounded by an insulating bead typically include a stepped or narrowed portion to attempt to match an impedance of the stepped or narrowed portion to the portion of coaxial signal conductor that is surrounded by an electrically non-conductive cable insulator or jacket of a coaxial cable.

### SUMMARY OF THE INVENTION

Embodiments of the present invention provide insulating beads that can be used with RF connectors and that can have relatively complex physical structures. In particular, the insulating beads can be manufactured by additive manufacturing processes, for example, by manufacturing insulating beads with a three-dimensional (3D) printer.

Accordingly, insulating beads can be provided with a non-solid structure, such as a lattice structure, a mesh structure, or the like, and impedance tuning of the Insulating beads can be easily controlled during the manufacturing process. Since the impedance tuning of the Insulating beads can be easily controlled, the coaxial signal conductor can be impedance matched without including a stepped or narrowed portion in the coaxial signal conductor.

According to an embodiment of the present invention, an electrical connector can include a connector housing, a conductor, and a 3D printed or non-extruded insulating bead that electrically insulates a portion of the conductor from the connector housing.

The insulating bead can have a substantially cylindrical shape with a center hole. The center hole can have a constant diameter through the insulating bead. The center hole can have a tapered shape and/or can have a stepped shape.

The insulating bead can be configured to filter at least one frequency or frequency band. The insulating bead can be defined by a tuned lattice or mesh structure. The insulating bead can at least partially include a repeating, ordered structure. The insulating bead can include a network of interconnected struts.

The insulating bead can have a solid shape with a center hole. The insulating bead can include a center hole and a void space other than the center hole.

The insulating bead can include an electrically non-conductive material or an electrically non-conductive, magnetic-absorbing material. The insulating bead can include a light-cured photopolymer resin.

The insulating bead can tune the electrical connector to provide predetermined impedance characteristics.

According to an embodiment of the present invention, a method of tuning an RF connector can included determining a structure of an insulating bead that provides at least one of predetermined impedance characteristics, predetermined mechanical characteristics, and predetermined thermal characteristics; and forming the insulating bead by an additive manufacturing process.

The additive manufacturing process can be a three-dimensional printing process. The process of determining the structure of the insulating bead can include a process of determining a lattice or mesh structure that is defined by a combined structure of one or more predetermined cells. The process of determining the structure of the insulating bead can further include a process modifying or confirming one or more of the predetermined cells to provide the combined structure. The process of determining the structure can include modeling local fields. The process of determining the structure can include iteratively determining the structure until the at least one of predetermined impedance characteristics, predetermined mechanical characteristics, and predetermined thermal characteristics is provided.

According to an embodiment of the present invention, an RF connector can include an electrically conductive housing, a conductor, and an insulating bead that electrically insulates the conductor from the electrically conductive housing. The insulating bead can include a plurality of void spaces. The insulating bead can define a lattice structure.

The insulating bead can include or can be made from a non-extruded photopolymer. The insulating bead can be one or more of pliable, compliant, elastic and/or capable of non-plastic deformation. The insulating bead can be 3D printed. The insulating bead can have a lattice structure selected to produce an impedance selected from a group comprising 50±1 Ω, 50±2 Ω, and 50±3 Ω. The conductor can define a cutoff or groove having a conductor width, the cutoff or groove can be configured to receive the insulating bead, and the cutoff or groove can have a wider conductor width compared to a conductor that is configured with a molded insulating bead.

The above and other features, elements, characteristics, steps, and advantages of the present invention will become more apparent from the following detailed description of the embodiments of the present invention with reference to the attached drawings.

### BRIEF DESCRIPTION OF THE DRAWINGS

FIG. 1 is a perspective top view of an RF connector.

FIG. 2 is a perspective bottom view of the RF connector shown in FIG. 1.

FIG. 3 is a perspective cross-sectional view of the RF connector shown in FIG. 1.

FIG. 4 is a perspective top view of an insulating bead that can be used in the RF connector shown in FIG. 1.

FIG. 5 is a bottom perspective view of the insulating bead shown in FIG. 4.

FIG. 6 is a cross-sectional view of the insulating bead shown in FIG. 4.

FIGS. 7A-7F are top perspective views of Insulating beads with various structures.

### DETAILED DESCRIPTION

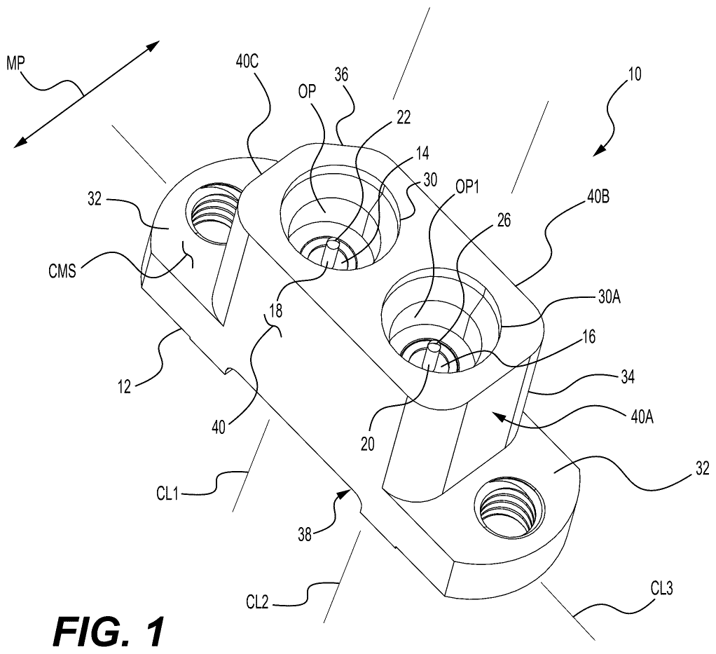

FIGS. 1-3 show a vertical RF connector disclosed in U.S. patent application Ser. No. 17/675,688, filed on Feb. 18, 2022. The entire contents of this application are hereby incorporated by reference.

FIGS. 1-3 show a multi-port, vertical, RF compression connector 10. The RF connector 10 can include a housing 12, a first insulating bead 14, a second insulating bead 16, a first conductor 18 including a first conductor end 22 and a second conductor end 24, a second conductor 20 including a third conductor end 26 and a fourth conductor end 28, a pair or at least two immediately adjacent ports 30, 30A, one or more compression mounts 32, a mating block 34, a polarization feature 36, and a recessed area 38. The housing 12 can include a mating end or mating interface to which a corresponding connector can be mated and a mounting end or a mounting interface that can be mounted to a suitable substrate, e.g., test substrate, PCB, etc.

FIG. 1 shows a top view of the RF connector 10. The housing 12 can be a single-piece, unitary, monolithic, or mono-block housing and can be made from an electrically conductive material, for example, metal. Alternatively, the housing 12 can be a multi-piece, integral housing. The housing 12 can have a length, measured across both compression mounts 32, of approximately 0.45 inches, 0.5 inches, 0.55 inches, etc. The housing 12 can have a width of approximately 0.15 inches, 0.16 inches, 0.17 inches, etc. Each first insulating bead 14 and each second insulating bead 16 can be made from an electrically non-conductive material, for example, plastic, or an electrically non-conductive, magnetic-absorbing material, for example, a ferro-magnetic ceramic. The first insulating bead 14 can be positioned in a first opening OP defined by the housing 10. The second insulating bead 16 can be positioned in a second opening OP1 defined by the housing 10.

Each of the first conductor 18 and the second conductor 20 can be made from an electrically conductive material, for example, metal, and can be stamped, formed, machined, and the like. The first and second conductors 18, 20 can both have the same size and shape or substantially the same size and shape. The first and second conductors 18, 20 can be spaced apart by a center-to-center distance of about 0.13 inches, 0.14 inches, etc. The first conductor end 22 of the first conductor 18 can extend into the first opening OP and can extend past or beyond the first insulating bead 14. A third conductor end 26 of the second conductor 20 can extend into second opening OP1 and can extend past the second insulating bead 16. The first conductor 18 can be straight or substantially straight, with its entire length extending along a first centerline CL1 that can be oriented perpendicular or substantially perpendicular within manufacturing and/or measurement tolerances to a third centerline CL3 and perpendicular or substantially perpendicular within manufacturing and/or measurement tolerances to a first surface of a mounting substrate. The second conductor 20 conductor can be straight or substantially straight, with its entire length extending along a second centerline CL2 that is oriented parallel or substantially parallel within manufacturing and/or measurement tolerances to the first centerline CL1, perpendicular or substantially perpendicular within manufacturing and/or measurement tolerances to the third centerline CL3 and perpendicular or substantially perpendicular within manufacturing and/or measurement tolerances to the first surface of the mounting substrate. The first conductor 18 can be devoid of bends or curves. The second conductor 20 can be devoid of bends or curves.

Each of the ports 30, 30A can be defined by the housing 12 or the mating block 34 of the housing 12. Each port 30, 30A can include a respective opening OP, OP1 defined by the housing 12, a respective one of the first insulating bead 14 or the second insulating bead 16 positioned in the respective opening OP, OP1, and a respective one of the first conductor 18 or the second conductor 20 positioned in the respective opening OP, OP1. The ports 30, 30A can be devoid of internal threads, devoid of external threads, or both. The mating block 34 can be devoid of internal threads, devoid of external threads, or both.

The housing 12 or the mating block 34 of the housing 12 can define at least two consecutive ports 30, 30A, as shown in FIG. 1. The ports 30, 30A can be oriented parallel or substantially parallel within manufacturing and/or measurement tolerances to each other. The first and second ports 30, 30A and/or the first and second centerlines CL1, CL2 can each form an angle of approximately 30° to approximately 90° with respect to the third centerline CL3 and a plane MP that a majority of the compression mount 32 lies in, with 90° suitable for many vertical RF connector 10 applications. Each compression mount 32 can have a major compression mount surface CMS that lies substantially in the plane MP.

The housing 12 can further define one compression mount 32, or two or more spaced-apart compression mounts 32. Each compression mount 32 can be positioned on opposed ends of the housing 12, along the third centerline CL3, with the ports 30, 30A and the mating block 34 positioned between the two spaced-apart or opposed compression mounts 32. Each compression mount 32 can be internally threaded and configured to receive a respective externally threaded fastener (not shown). Each compression mount 32, the first conductor 18, and the second conductor 20 can each lie along the third centerline CL3.

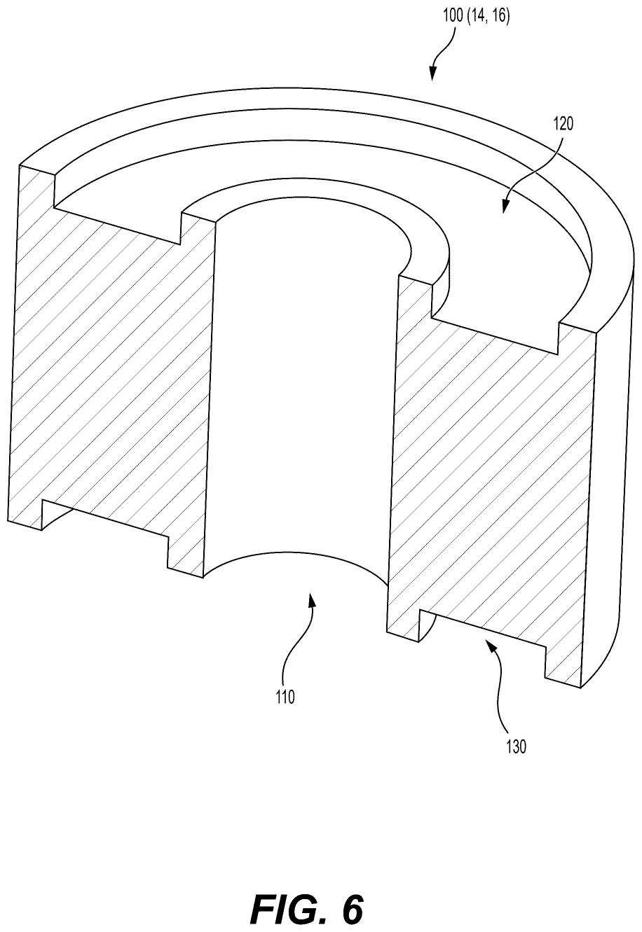

The mating block 34 can be defined by the combination of a first wall 40, a second wall, 40A, a third wall 40B, and a fourth wall 40C. The mating block 34 can define at least three corners or at least three radiused corners, can be elevated above or extend from the compression mounts 32, and can define at least one or only one polarization feature 36. The polarization feature 36 can be a beveled surface defined at one corner or one radiused corner of the mating block 34 portion of the housing 12. Recessed area 38 of the housing 12 can be defined beneath the mating block 34 of the housing 12. It is possible that no respective portion of the first conductor 18 or the second conductor 20 extends beyond the first, second, third, or fourth walls 40-40C. A first end of a mating cable, as discussed herein with respect to FIGS. 6-9, can friction fit over the first, second, third, and fourth walls 40-40C of the mating block 34.

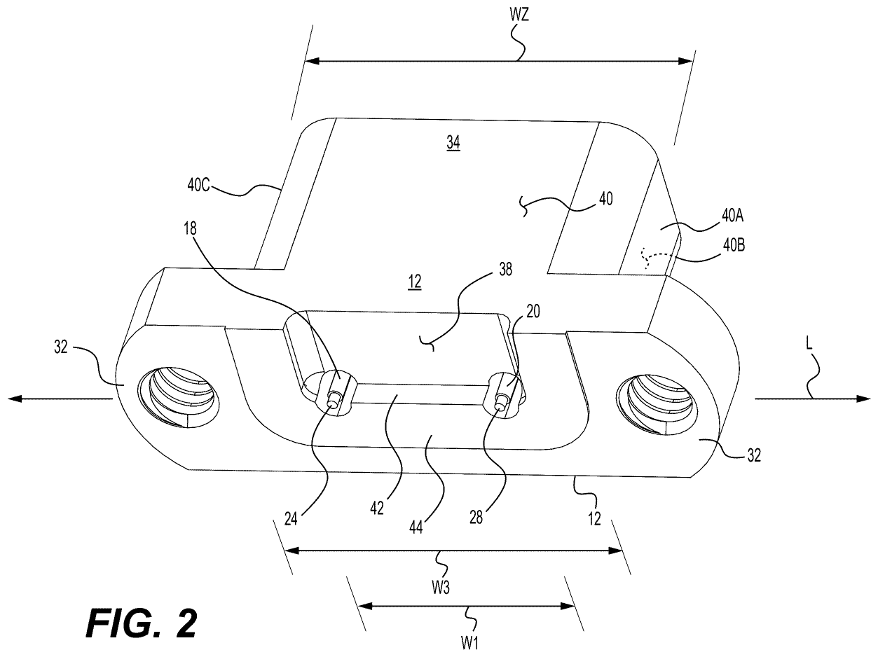

FIG. 2 is a bottom perspective view of the RF connector 10 shown in FIG. 1. The second conductor end 24 of the first conductor 18 and a fourth conductor end 28 of the second conductor 20 can each terminate at the recessed area 38 of the housing 12, between the compression mounts 32, and under the mating block 34. The second conductor end 24 and the fourth conductor end 28 can both be compression mounted to a mounting substrate (not shown). The second conductor end 24, the fourth conductor end 28, or both can be butt-coupled to a corresponding, respective pad on the mounting substrate. Each pad can include a point on the mounting substrate coincident with an arc, circle, or curve of the mounting substrate such that at least two or at least three consecutive trace lengths that extent from the center of each respective pad to are equal in physical length, electrical length, or both physical length and electrical length. The recessed area 38 can define a first recess 42 and a second recess 44. The first recess 42 can have a first width W1 along a longitudinal direction L that is less than a second external wall-to-wall width W2 measured between second and fourth walls 40A, 40C of the mating block 34 of the housing 12, along the longitudinal direction L. The second recess 44 can have a third width W3 along a longitudinal direction L that is less than the second external wall-to-wall width W2 measured between second and fourth walls 40A, 40C of the mating block 34 of the housing 12, along the longitudinal direction L. The second recess 44 can have a third width W3 along a longitudinal direction L that is greater than the first width W1 along the longitudinal direction L. Second width W2 can be greater than either the first width W1 or the third width W3. The first recess 42 and the second recess 44 can each be open-ended adjacent to the first wall 40 of the mating block 34 or extend all the way to an external surface of the first wall 40. The first recess 42 and the second recess 44 can each be closed-ended adjacent to the third wall 40B of the mating block 34 or not extend all the way to an external surface of the third wall 40B of the mating block 34. The first conductor end 22 and the fourth conductor end 28 can both terminate in the recessed area 38, the first recess 42, or the second recess 44, and can both not terminate outside of the recessed area 38. The first conductor end 22 and the fourth conductor end 28 can both butt-couple terminate to a corresponding pad or trace on a mounting substrate (not shown).

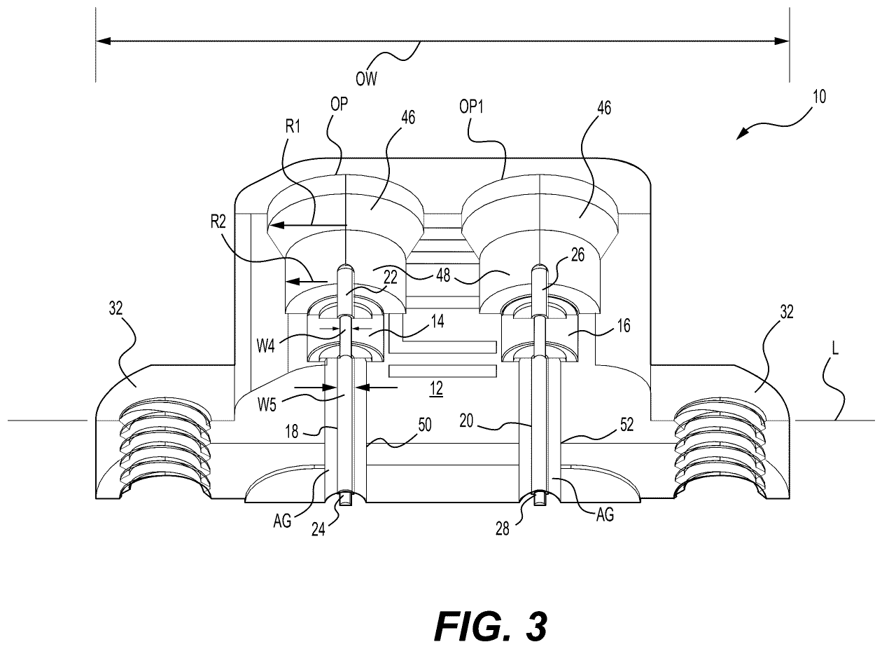

FIG. 3 is cross-sectional view of the RF connector 10 of FIGS. 1 and 2. The first conductor 18 and second conductor 20 can both be electrically insulated from the housing 12. Housing 12 can define one or more compression mounts 32. Each respective opening OP, OP1 can define a first opening 46 that has a first radius R1, circumference, or area and a second opening 48 that has a second radius R2, circumference, or area. A first radius R1, circumference, or area of the first opening 46 is greater than a second radius R2, circumference, or area of the second opening 48. Respective first insulating bead 14 and second insulating bead 16 may each be positioned adjacent to a corresponding second opening 48 of each respective port 30, 30A. One or both of the first insulating bead 14 and second insulating bead 16 can include a recessed portion or recessed portions on a circumferential surface thereof, and the recessed portion or recessed portions can mate with a corresponding protrusion or protrusions of the housing 12 to help retain the first insulating bead 14 and/or the second insulating bead 16 within the housing 12. Alternatively or in addition, one or both of the first insulating bead 14 and second insulating bead 16 can include a protrusion or protrusions on a circumferential surface thereof, and the protrusion or protrusions can mate with a corresponding recessed portion or recessed portions of the housing 12.

In FIG. 3, for clarity, the first insulating bead 14 and the second insulating bead 16 are shown as see through, but the first insulating bead 14 and the second insulating bead 16 can be opaque and do not have to be transparent. First conductor 18 and second conductor 20 may each have a respective first conductor width W4 inside a respective one of the first insulating bead 14 or the second insulating bead 16. First conductor 18 and second conductor 20 may each have a respective second conductor width W5 outside of a respective one of the first insulating bead 14 or the second insulating bead 16, where the second conductor width W5 is greater in length than the first conductor width W4. An overall width OW of the housing 12, along the longitudinal direction L, can be smaller in width than two single-port, compression, vertical RF connectors each positioned end-to-end along a common line.

The housing 12 can have a first footprint area that is smaller than a second combined footprint area of two single-port, compression, vertical RF compression connectors.

First conductor 18, second conductor 20, second conductor end 24, and fourth conductor end 28 can each be spaced from a respective first internal wall 50 or second internal wall 52 of the housing 12 and separated from the housing 12 by an air gap AG or other electrical insulating bead. The first conductor end 22 of the first conductor 18 and the third conductor end 26 of the second conductor 20 can each extend into a respective opening OP, OP1. The first conductor end 22 of the first conductor 18 and the third conductor end 26 of the second conductor 20 can each extend into a respective second opening 48 of a respective port 30, 30A. Alternatively, respective first and third conductor ends 22, 26 can each extend into both the first and second openings 46, 48 defined by the housing 12 or the mating block 34 of the housing 12.

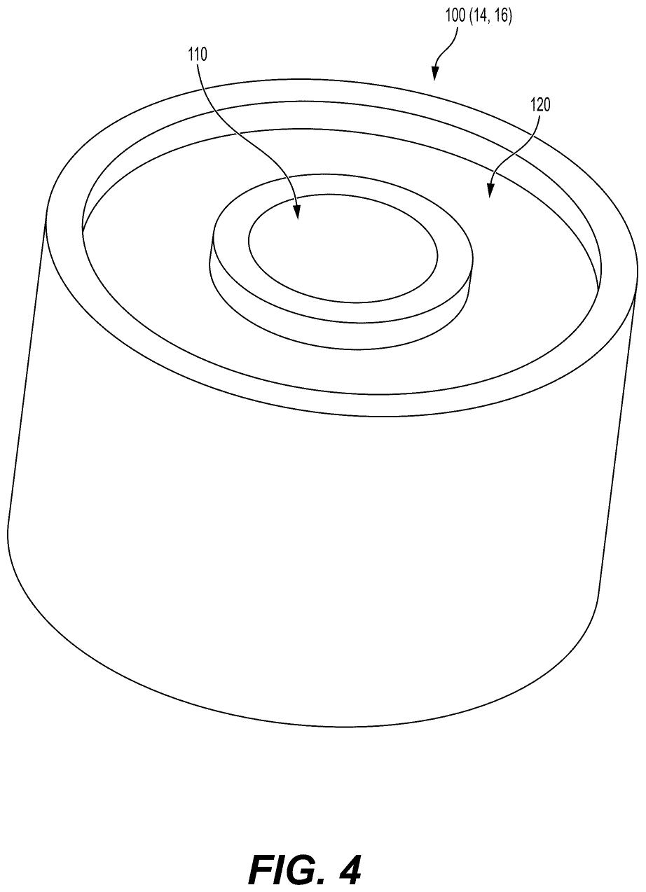

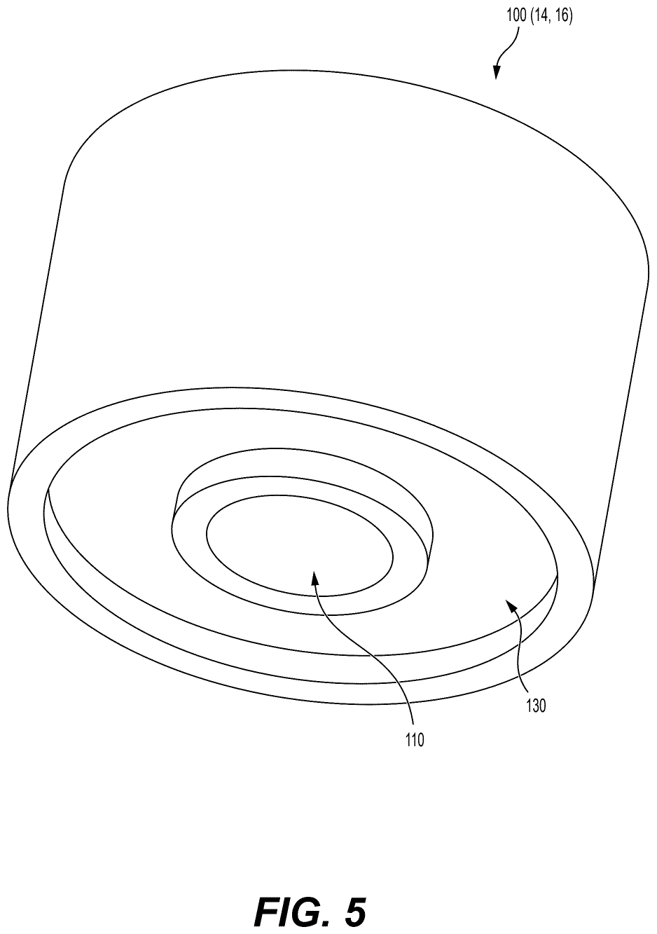

Although the RF connector 10 shown in FIGS. 1-3 includes two ports, the insulating beads shown in FIGS. 4-7F can be used in RF connectors that include only a single port or that include more than two ports.

FIGS. 4-6 show a third insulating bead 100 that can be used as the first insulating bead 14 or the second insulating bead 16 shown in FIGS. 1-3.

As shown in FIGS. 4-6, the third insulating bead 100 can have a substantially cylindrical shape and can include a center hole 110, a first groove 120, and a second groove 130. The center hole 110 can receive an electrical conductor, for example, the first conductor 18 or the second conductor 20 shown in FIGS. 1-3. The center hole 110 can have a constant diameter, a tapered shape, or a stepped shape. The first groove 120 and the second groove 130 can facilitate mating of the third insulating bead 100 with an RF connector, for example, the RF connector 10 shown in FIGS. 1-3.

The third insulating bead 100 can be made from an electrically non-conductive material, for example, plastic or resin, or an electrically non-conductive, magnetic-absorbing material, for example, a ferro-magnetic ceramic. In addition, the third insulating bead 100 can include a material that is not solid in a cross-section of the insulating bead 100, including a structure defined by a lattice or a mesh structure, as described below with respect to the fourth, fifth, sixth, seventh, eighth, and ninth insulating beads 200, 300, 400, 500, 600, and 700.

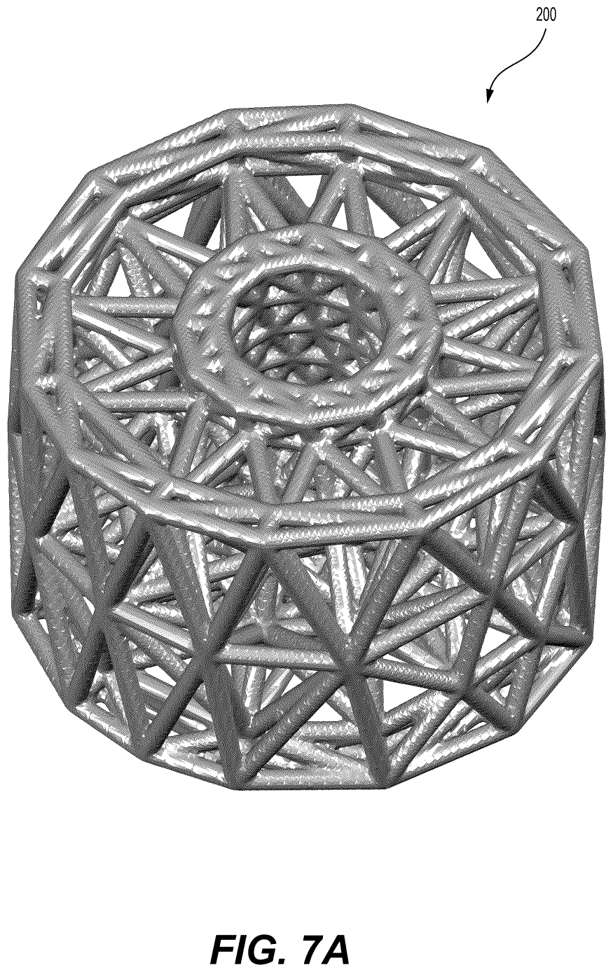

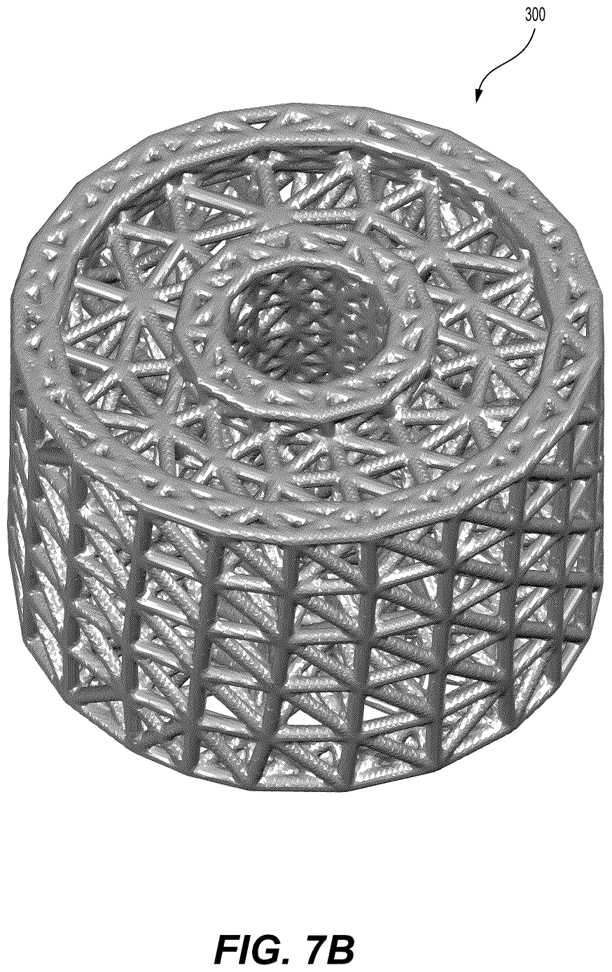

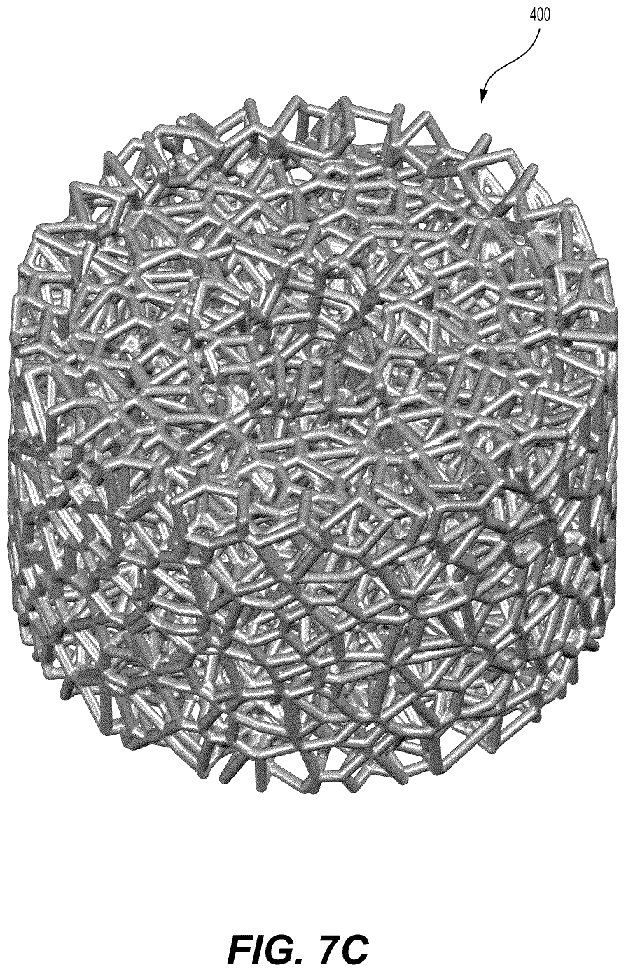

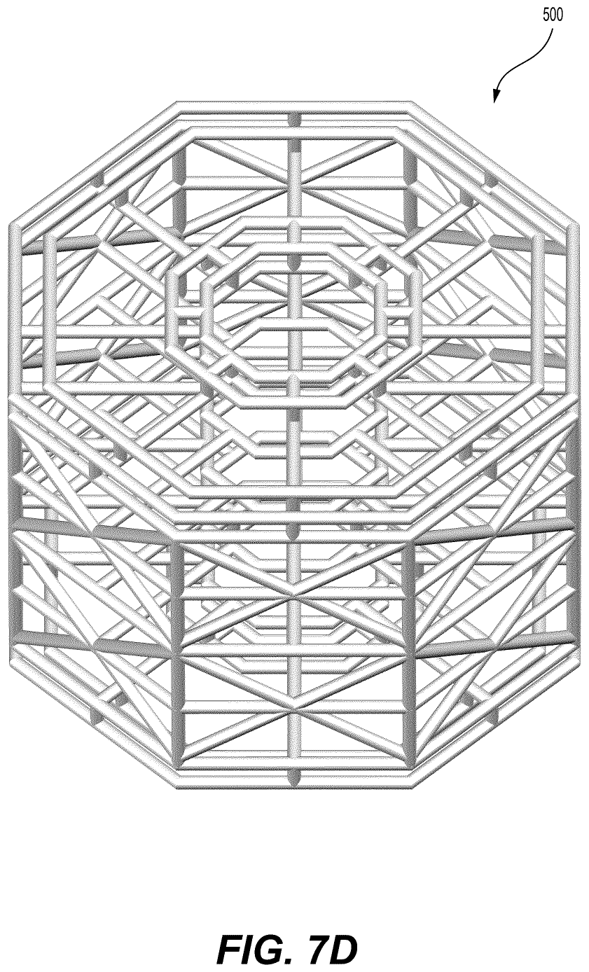

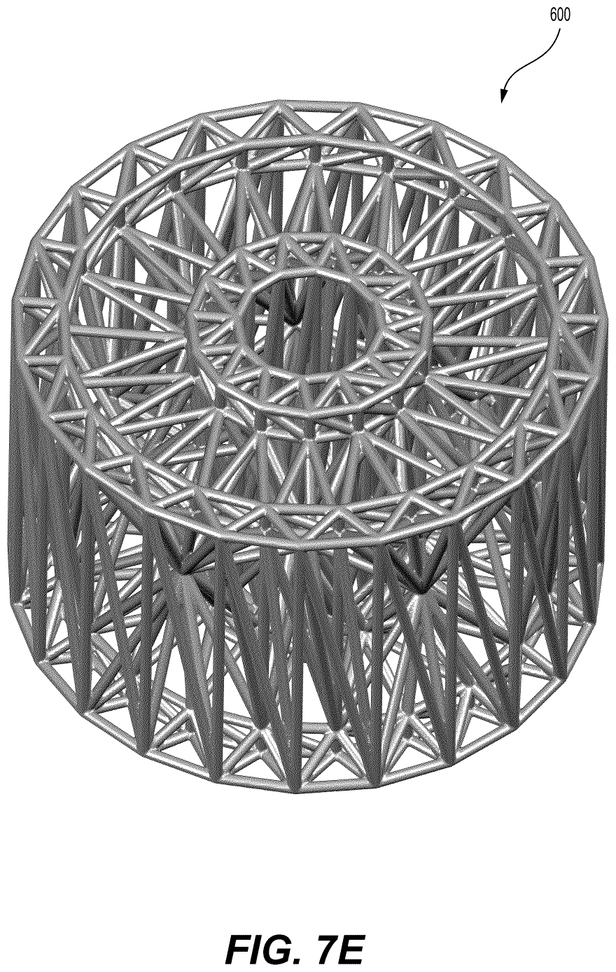

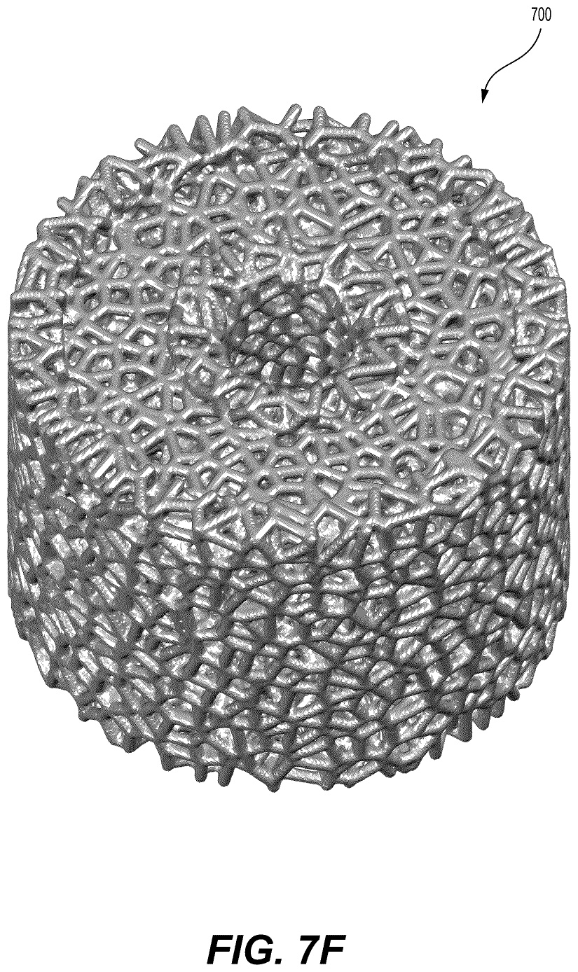

As shown in FIGS. 7A-7F, a fourth insulating bead 200, a fifth insulating bead 300, a sixth insulating bead 400, a seventh insulating bead 500, an eighth insulating bead 600, and a ninth insulating bead 700 can each include a center hole similar to the center hole 110 shown in FIGS. 4-6. Further, grooves similar to the first groove 120 and the second groove 130 shown in FIGS. 4-6 can be provided in the fourth, fifth, sixth, seventh, eighth, and ninth insulating beads 200, 300, 400, 500, 600, and 700 shown in FIGS. 7A-7F.

As shown in FIGS. 7A-7F, each of the fourth, fifth, sixth, seventh, eighth, and ninth insulating beads 200, 300, 400, 500, 600, and 700 can be formed with a lattice or a mesh structure. That is, the structure can have a repeating, ordered structure as a tuned lattice (for example, point symmetry or radial symmetry in a cross-sectional view), a random structure as a mesh structure, or a combination of a tuned lattice and a mesh structure. In addition, each of the fourth, fifth, sixth, seventh, eighth, and ninth insulating beads 200, 300, 400, 500, 600, and 700 can include a material that is not solid in a cross-section of the insulating bead, including a structure defined by a tuned lattice or a mesh structure. That is, each of the fourth, fifth, sixth, seventh, eighth, and ninth insulating beads 200, 300, 400, 500, 600, and 700 can include a void space or a plurality of void spaces other than the center hole and other than any recess provided in an exterior surface of the fourth, fifth, sixth, seventh, eighth, and ninth insulating beads 200, 300, 400, 500, 600, and 700. The void spaces can include air or an electrical dielectric material that has a dielectric constant that is different from a dielectric constant of the electrical dielectric material of the solid portions of the fourth, fifth, sixth, seventh, eighth, and ninth insulating beads 200, 300, 400, 500, 600, and 700. The number of void spaces can be at least two, more than two, three or more, four or more, five or more, six or more, seven or more, eight or more, nine or more, ten or more, more than ten, more than twenty, more than thirty, more than forty, more than fifty, fifty or more, or 100 or more. With a lattice having a repeating, ordered structure, the number of void spaces in one half of a cross section is equal to the number of void spaces in the other half of the cross section. By including a tuned lattice or mesh structure, each of the fourth, fifth, sixth, seventh, eighth, and ninth insulating beads 200, 300, 400, 500, 600, and 700 can be provided with structural rigidity in a relatively compact size, while also reducing the dielectric constant to help provide a higher cut-off frequency. The lattice or mesh structure can also precisely and accurately locate the center hole in each of the fourth, fifth, sixth, seventh, eighth, and ninth insulating beads 200, 300, 400, 500, 600, and 700. Each of the fourth, fifth, sixth, seventh, eighth, and ninth insulating beads 200, 300, 400, 500, 600, and 700 can be defined by a porous structure or a solid foam that has any one of a network of open cells, a network of closed cells, or a network of both open cells and closed cells.

Each of the fourth, fifth, sixth, seventh, eighth, and ninth insulating beads 200, 300, 400, 500, 600, and 700 can be manufactured by additive manufacturing processes, for example, by a three-dimensional (3D) printing process. The additive manufacturing process can provide the structures shown in FIGS. 7A-7F by creating a network of interconnected struts that can have a diameter of about 17 μm. However, other additive manufacturing processes may be implemented, for example, to provide struts that have a diameter of about 5 μm or less. Each of the fourth, fifth, sixth, seventh, eighth, and ninth insulating beads 200, 300, 400, 500, 600, and 700 do not have to be extruded.

Each of the fourth, fifth, sixth, seventh, eighth, and ninth insulating beads 200, 300, 400, 500, 600, and 700 can be made from an electrically non-conductive material, for example, plastic, or can be made from an electrically non-conductive, magnetic-absorbing material, for example, a ferro-magnetic ceramic. In other applications, each of the fourth, fifth, sixth, seventh, eighth, and ninth insulating beads 200, 300, 400, 500, 600, and 700 can include an electrically conductive material, for example, carbon nanotubes or silver particles. Each of the fourth, fifth, sixth, seventh, eighth, and ninth insulating beads 200, 300, 400, 500, 600, and 700 can be made from a material that can be deposited by a 3D printing process.

In particular, each of the fourth, fifth, sixth, seventh, eighth, and ninth insulating beads 200, 300, 400, 500, 600, and 700 can be a light-cured photopolymer resin that can be used in stereolithography (SLA) and digital light processing (DLP) processes. The light-cured photopolymer resin can be a thermoset polymer that has cross-linking induced by exposure to light of a predetermined frequency. The light-cured photopolymer resin may include photo-initiators that form a radical to initiate cross-linking, or may include thermoplastic polymers that do not have cross-linking. The additive manufacturing process can be implemented by a high-resolution 3D printer having a resolution of about 2 μm, for example, the MICROARCH S230 by BOSTON MICRO FABRICATION. However, 3D printers of other resolutions may be used, for example, a resolution on the order of about 200 nm.

By providing each of the fourth, fifth, sixth, seventh, eighth, and ninth insulating beads 200, 300, 400, 500, 600, and 700 with a lattice or mesh structuring including the above-described materials, impedance tuning and predetermined characteristics can be easily achieved, particularly when compared with known materials such a fluoropolymers. In addition, insulating beads of a reduced size can also be obtained.

As other examples, a material of each of the fourth, fifth, sixth, seventh, eighth, and ninth insulating beads 200, 300, 400, 500, 600, and 700 can include additives, for example, particle additives or fiber additives.

As described with respect to FIG. 3, the first conductor 18 and second conductor 20 may each have a respective first conductor width W4 inside a respective one of the first insulating bead 14 or the second insulating bead 16, and the first conductor 18 and second conductor 20 may each have a respective second conductor width W5 outside of a respective one of the first insulating bead 14 or the second insulating bead 16. Each of the fourth, fifth, sixth, seventh, eighth, and ninth insulating beads 200, 300, 400, 500, 600, and 700 shown in FIGS. 7A-7F can be structured to tune an impedance of within the corresponding insulating bead 200, 300, 400, 500, 600, and 700 to match an impedance of the conductor outside of the corresponding insulating bead 200, 300, 400, 500, 600, and 700. Accordingly, an RF connector that includes one or more of the fourth, fifth, sixth, seventh, eighth, and ninth insulating beads 200, 300, 400, 500, 600, and 700 may include one or more conductors with constant widths. That is, a conductor provided with one of the fourth, fifth, sixth, seventh, eighth, and ninth insulating beads 200, 300, 400, 500, 600, and 700 can have a respective first conductor width W4 that is equal or substantially equal to, within manufacturing and/or measurement tolerances, the second conductor width W5. Alternatively, a first and/or second conductor 18, 20 can define a first conductor width W4 that is less than a second conductor width W5 but, when compared to a respective first and/or second conductor 18, 20 configured with an extruded or solid first or second dielectric insulating bead 14, 16 instead of a third, fourth, fifth, sixth, seventh, eighth, or ninth insulating bead 100, 200, 300, 400, 500, 600, or 700, has a larger or greater first conductor width W4. Stated another way, the first conductor 18 can define a first cutoff or first groove having a first conductor width W4. The first conductor width W4 can be less than the second conductor width W5. The first cutoff or first groove can be configured to receive any one of the third, fourth, fifth, sixth, seventh, eighth, and ninth insulating beads 100, 200, 300, 400, 500, 600, and 700. The first cutoff or first groove can be wider or can have a larger first conductor width W4 compared to the first conductor width W4 of a first conductor 18 configured with a molded or extruded first insulating bead 14.

An RF connector can be provided with an insulating bead that is tuned to predetermined impedance characteristics. For example, predetermined impedance characteristics can be determined of an insulating bead, and the insulating bead can then be manufactured by an additive manufacturing process that is controlled to provide the predetermined impedance characteristics in the insulating bead. The RF connector can be devoid of any solid dielectric material or any foam dielectric with irregularly shaped, non-repeating voids.

A method according to the embodiments of the present invention can include the step of tuning an impedance of an electrical connector by tuning an impedance of an insulating bead carried by the electrical connector. A method according to the embodiments of the present invention can include the step of tuning an impedance of an electrical signal conductor by tuning an impedance of a corresponding insulating bead that at least partially circumscribes or surrounds the electrical signal conductor. A method according to the embodiments of the present invention can include the steps of determining a desired, target, or predetermined impedance for an electrical connector or an electrical signal conductor and designing an insulating bead that permits the desired, target, or predetermined impedance to be met, within a margin of error of +/−10 Ω, +/−5 Ω, +/−1 Ω, or +/−0.1 Ω. A desired, target, system, or predetermined impedance can be, for example, 50 Ω, 60 Ω, 70 Ω, 75 Ω, 77 Ω, 85 Ω, or 100 Ω.

A process of tuning an RF connector can include first determining an impedance profile for the RF connector, determining a structure of an insulating bead that provides the impedance profile, and then forming the insulating bead by an additive manufacturing process. Accordingly, the embodiments of the present invention solve a long-felt need of tuning an impedance profile of an electrical connector by only changing an insulating bead included in the electrical connector. In addition, an impedance-tuned insulating bead including void spaces is able to occupy the same space or volume within the electrical connector as a solid insulating bead, which enables an electrical connector to be modified for different impedance applications by only determining a new design for an insulating bead and then printing the insulating bead, thereby reducing tooling costs and design time.

The process of determining the structure of the insulating bead can include a process of determining a lattice or mesh that is defined by a combined structure of one or more predetermined cells. In addition, the process of determining the structure of the insulating bead can further include a process modifying or confirming one or more of the predetermined cells to provide the combined structure. A shape and size of the voids in the combined structure can be determined by modeling local fields, or by an iterative process until predetermined characteristics are obtained. The structure of the insulating bead can be adjusted to separately or collectively adjust one or more of mechanical characteristics, electrical characteristics (e.g., a predetermined dielectric constant), and thermal characteristics. As one example, in an application that does not require high mechanical performance, fine structures may be included to precisely adjust electrical characteristics and/or thermal characteristics. The combined structure can also be determined so that specific frequencies or frequency bands are filtered, for example, unwanted resonant frequencies, or to provide broad band filtering. Accordingly, since the insulating bead can filter out specific frequencies or frequency bands, separate circuitry (for example, an RLC circuit) that is used with known RF connectors and insulating beads may be omitted.

At least a portion of the process of tuning the RF connector can be implemented by computer-aided design (CAD) software. The additive manufacturing processes can be a three-dimensional printing process.

In partial summary, a RF connector can include an electrically conductive housing 12, a first conductor 18, and any one of a third, fourth, fifth, sixth, seventh, eighth, or ninth insulating bead 100, 200, 300, 400, 500, 600, or 700 that electrically insulates the first conductor 18 from the electrically conductive housing 12. Any of the third, fourth, fifth, sixth, seventh, eighth, and ninth insulating beads 100, 200, 300, 400, 500, 600, and 700 can define a lattice structure. The third, fourth, fifth, sixth, seventh, eighth, and ninth insulating beads 100, 200, 300, 400, 500, 600, and 700 can be made from a non-extruded photopolymer. The third, fourth, fifth, sixth, seventh, eighth, and ninth insulating beads 100, 200, 300, 400, 500, 600, and 700 can define a lattice structure. The third, fourth, fifth, sixth, seventh, eighth, and ninth insulating beads 100, 200, 300, 400, 500, 600, and 700 can be one or more of pliable, compliant, elastic and/or capable of non-plastic deformation. The third, fourth, fifth, sixth, seventh, eighth, and ninth insulating beads 100, 200, 300, 400, 500, 600, and 700 can be 3D printed. One or more of the third, fourth, fifth, sixth, seventh, eighth, and ninth insulating beads 100, 200, 300, 400, 500, 600, and 700 can have or define a lattice structure selected to produce an impedance selected from a group comprising 50±1 Ω, 50±2 Ω, and 50±3 Ω. The first conductor 18 can define a first cutoff or first groove having a first conductor width W4, the first cutoff or first groove can be configured to receive any one of the third, fourth, fifth, sixth, seventh, eighth, and ninth insulating beads 100, 200, 300, 400, 500, 600, and 700. The first cutoff or first groove can have wider first conductor width W4 compared to a first conductor 18 configured with a molded first insulating bead 14.

Although a first conductor 18 and a third, fourth, fifth, sixth, seventh, eighth, or ninth insulating bead 100, 200, 300, 400, 500, 600, or 700 is described, a second conductor 20 can also be configured with or carry a third, fourth, fifth, sixth, seventh, eighth, or ninth insulating bead 100, 200, 300, 400, 500, 600, or 700. While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure is not limited to the particular embodiments disclosed herein, but that the disclosure will include all embodiments falling within the scope of the appended claims.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

1. An electrical connector comprising:
a connector housing;
a conductor; and
a three-dimensional (3D) printed or non-extruded insulating bead that is defined by a tuned lattice or mesh structure and that electrically insulates a portion of the conductor from the connector housing.

2. The electrical connector according to claim 1, wherein the insulating bead has a substantially cylindrical shape with a center hole.

3. The electrical connector according to claim 2, wherein the center hole has a constant diameter through the insulating bead.

4. The electrical connector according to claim 2, wherein the center hole has a tapered shape.

5. The electrical connector according to claim 2, wherein the center hole has a stepped shape.

6. The electrical connector according to claim 1, wherein the insulating bead is configured to filter at least one frequency or frequency band.

7. (canceled)

8. The electrical connector according to claim 1, wherein the insulating bead at least partially includes a repeating, ordered structure.

9. The electrical connector according to claim 1, wherein the insulating bead includes a network of interconnected struts.

10. The electrical connector according to claim 1, wherein the insulating bead has a solid shape with a center hole.

11. The electrical connector according to claim 1, wherein the insulating bead includes a center hole and a void space other than the center hole.

12. The electrical connector according to claim 1, wherein the insulating bead includes an electrically non-conductive material or an electrically non-conductive, magnetic-absorbing material.

13. The electrical connector according to claim 1, wherein the insulating bead includes a light-cured photopolymer resin.

14. The electrical connector according to claim 1, wherein the insulating bead tunes the electrical connector to provide predetermined impedance characteristics.

15-20. (canceled)

21. A RF connector comprising:
an electrically conductive housing;
a conductor; and
an insulating bead that electrically insulates the conductor from the electrically conductive housing, wherein
the insulating bead defines a lattice structure including a plurality of void spaces.

22. The RF connector of claim 21, wherein the insulating bead includes a non-extruded photopolymer.

23. (canceled)

24. The RF connector of claim 21, wherein the insulating bead is one or more of pliable, compliant, elastic, and capable of non-plastic deformation.

25. The RF connector of claim 21, wherein the insulating bead is three-dimensionally (3D) printed.

26. The RF connector of claim 21, wherein the insulating bead has a lattice structure selected to produce an impedance selected from a group comprising 50±1 Ω, 50±2 Ω, and 50±3 Ω.

27. The RF connector of claim 21, wherein:
the conductor defines a cutoff or groove having a conductor width,
the cutoff or groove is configured to receive the insulating bead, and
the cutoff or first groove has a wider conductor width compared to a conductor that is configured with a molded insulating bead.

28. The electrical connector according to claim 1, wherein the conductor extends through the insulating bead.

29. The RF connector of claim 21, wherein the conductor extends through the insulating bead.
